(19) United States
(12) Patent Application Publication
(10) Pub. No.: US 2017/0301209 A1
(43) Pub. Date: Oct. 19, 2017

(54) INTERMEDIATE SUMP WARNING SYSTEM

(71) Applicant: SUKUP MANUFACTURING CO., Sheffield, IA (US)

(72) Inventors: Eugene G. Sukup, Hampton, IA (US); Graham Giddings, Sheffield, IA (US); Elizabeth Brinkman, Greene, IA (US); Randal L. Marcks, St. Ansgar, IA (US); Charles E. Sukup, Dougherty, IA (US)

(21) Appl. No.: 15/098,803

(22) Filed: Apr. 14, 2016

(51) Int. Cl. G08B 21/18; A01F 25/14

(52) U.S. Cl. CPC G08B 21/18; A01F 25/14

(57) ABSTRACT

An intermediate sump warning system having a sensor associated with a gate of an intermediate sump. The sensor is connected to a controller that activates a warning signal when the sensor detects that the gate is in an open position.

### BACKGROUND OF THE INVENTION

This invention is directed to a warning system for grain bins, and more particularly, a system that provides a warning signal when an intermediate sump is open.

Bins for storing grain are well-known in the art. Grain is removed from the bin through a centrally located sump and intermediate sumps. Typically, the intermediate sumps should not be opened when the bin is too full as the opening causes the sidewall sheets to be pulled in resulting in catastrophic bin failure if not caught immediately, and at least damage to the bin. Therefore, a need exists in the art for a system that addresses these deficiencies.

Therefore, an objective of the present invention is to prevent grain bin damage and failure.

Another objective of the present invention is to improve safety related to grain bin operation.

These and other objectives will be apparent to one skilled in the art based upon the following written description, drawings and claims.

### SUMMARY OF THE INVENTION

An intermediate sump warning system having a sensor associated with a gate of an intermediate sump. The sensor detects when the gate has rotated from a closed position to an open position and sends a signal to a controller. Upon detection of an open gate, the controller activates a warning signal such as a voice command, an arbitrary sound, and/or flashing lights.

### BRIEF DESCRIPTION OF THE DRAWINGS

FIG. 1 is a side sectional view of a grain bin; and

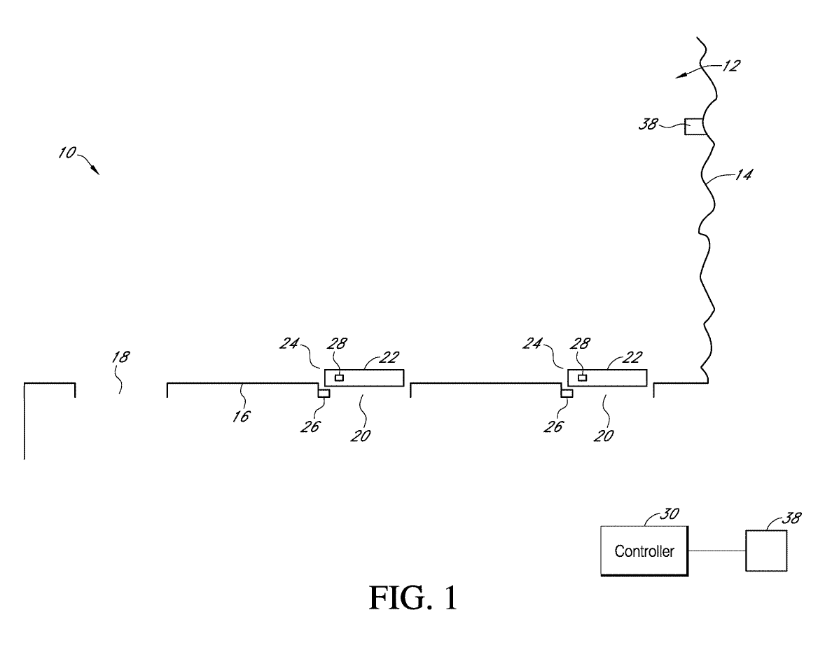

FIG. 2 is a block diagram of the environment for a sump warning system.

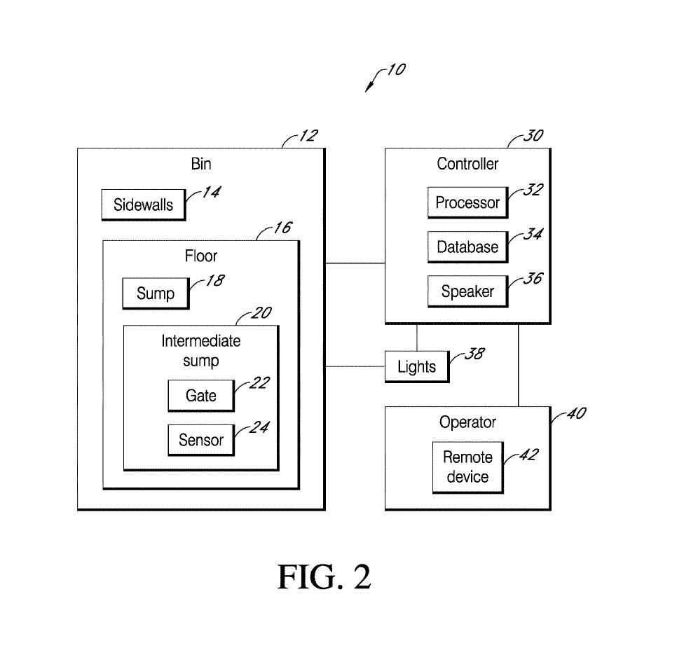

### DETAILED DESCRIPTION OF THE PREFERRED EMBODIMENT

Referring to the figures, an intermediate sump warning system 10 is used in relation to a bin 12 for storing grain. The bin 12 has a sidewall 14 and a floor 16. Disposed within the floor 16 is a centrally located sump 18 and intermediate sumps 20 positioned between the central sump 18 and the sidewall 14. The intermediate sumps 20 have a gate 22 that rotates between an open and closed position.

Associated with gate 22 is a sensor 24 that detects the position of gate 22. The sensor 24 is of any type and preferably is comprised of at least one magnet 26 and at least one magnetic reed switch 28. Connected to the sensor, either electrically or wirelessly is a controller 30 having a processor 32, a memory or database 34, and a speaker 36. The controller 30 may also be connected to a plurality of lights 38 positioned about the bin 12 and/or a remote location.

In operation, an operator 40 selects a desired warning signal that includes a voice command, an arbitrary sound, and/or blinking lights. A signal may also be sent to a remote device, such as a mobile phone or personal computer. The warning signal is selected using a laptop or similar remote device 42. When the sensors 24 detect that gates 22 are in an open position, the sensors 24 send signals to the controller 30. Upon receipt of the signal, the controller 30 activates in communication with the controller 30 the selected warning signal. The warning signal continues for a predetermined amount of time or until the controller 30 receives a signal from the sensors 24 indicating the gates 22 are in a closed position.

Thus, an intermediate sump warning system has been disclosed that at the very least meets all the stated objectives.

What is claimed:

1. An intermediate sump warning system, comprising:
an intermediate sump disposed in a floor of a grain bin between a centrally located sump and a sidewall of the grain bin and having a gate that rotates between an open and closed position;
wherein the gate is configured to permit removal of grain from the grain bin through the intermediate sump;
a sensor associated with the gate to detect when the gate is in the open or the closed position; and
a controller connected to the sensor and configured to activate a warning signal when the gate is in the open position.

2. The system of claim 1 wherein the sensor has at least one magnet and at least one magnetic reed switch.

3. The system of claim 1 wherein the warning signal is preselected by an operator.

4. The system of claim 1 wherein the warning signal is selected from a group consisting of a voice command, an arbitrary sound, and blinking lights.

5. The system of claim 1 wherein the warning signal continues for a preselected period of time.

6. The system of claim 1 wherein the warning signal continues until the gate is closed.

7. The system of claim 3 wherein the operator preselects the warning signal with a device remote of the controller.

8. The system of claim 1 wherein the controller sends the warning signal to a remote device.

9. An intermediate sump warning system, comprising:
a gate disposed in a floor of a grain bin;
a sensor associated with the gate to detect when the gate is in an open or closed position; and
a controller connected to the sensor and configured to activate a warning signal when the gate is in the open position.

10. The system of claim 9 wherein the gate is configured to permit removal of grain from the grain bin.

11. The system of claim 9 wherein the sensor includes at least one magnet and at least one magnetic reed switch.

12. An intermediate sump warning system, comprising:
an intermediate sump disposed in a floor of a grain bin and having a gate that rotates between an open and closed position;
a sensor associated with the gate to detect when the gate is in the open or the closed position;
a controller connected to the sensor and configured to activate a warning signal when the gate is in the open position; and
wherein the warning signal continues for a preselected period of time.
